(19) United States
(12) Patent Application Publication
(10) Pub. No.: US 2022/0052432 A1
(43) Pub. Date: Feb. 17, 2022

(54) FLANGED TORSION BOX CELL POLE

(71) Applicant: Comptek Technologies, LLC, Boulder, CO (US)

(72) Inventors: James D. Lockwood, Boulder, CO (US); Kenneth Michael Hoganson, Aurora, CO (US)

(21) Appl. No.: 17/382,522

(22) Filed: Jul. 22, 2021

Related U.S. Application Data
(60) Provisional application No. 63/055,178, filed on Jul. 22, 2020.

(51) Int. Cl. H01Q 1/12

(52) U.S. Cl. CPC H01Q 1/1242; H01Q 1/1228

(57) ABSTRACT

A cell pole that is easily manufactured, provides good structural qualities, permits near continuous vertical positioning of supported antennas while shrouding/concealing the supported antennas. The pole includes a central torsion box and a plurality of outwardly extending flanges. The pole provides significant structural rigidity based on the concepts of an I-beam. The pole may be produced in an extrusion molding process significantly reduces manufacturing costs.

### CROSS-REFERENCE

The present application claims the benefit of the filing date of U.S. Provisional Application No. having a filing date of Jul. 22, 2020, the entire contents of which is incorporated herein by reference.

### FIELD

The present disclosure is broadly directed to small cell poles that provide coverage for local service areas. More specifically, the present disclosure is directed to a cell pole that utilizes a torsion box and radial flange cross-sectional configuration to provide structural stability as well as improved adjustability for mounting one or more antennas.

### BACKGROUND

In wireless communication networks, high-powered base stations (e.g., towers supporting antennas) commonly provide service over large geographic areas. Each base station serves wireless user devices in a coverage area that is primarily determined by the power of the signals that supported antennas can transmit. Frequently, high-powered base stations (e.g., macro stations) are in a grid pattern with each base station mounting various antennas on a tower. While such towers have previously provided adequate coverage for many wireless applications, such high-powered base stations tend to be too widely spaced for newer high-bandwidth wireless applications.

To improve wireless access, providers are moving toward smaller stations that provide enhanced coverage for more limited geographic areas. That is, to augment the coverage of the wireless network, wireless transceiver devices/antennas (e.g., access points) with relatively small coverage areas (and serving capacities) are deployed. Depending on their coverage area and serving capacities, these wireless transceiver devices are referred to as “femto” cells or “pico” cells. For simplicity and generality, the term “small cell pole” is used herein to refer to a wireless transceiver access point that is configured to serve wireless user devices over relatively small coverage areas as compared to a high-powered base station that is configured to serve a relatively large coverage area (“macro cell”).

The increasing use of RF bandwidth or ‘mobile data’ has required a corresponding increase in the number of access points to handle the increased data. By way of example, 5G wireless networks promise greatly improved network speeds and are currently being planned and implemented. Such networks typically require shorter RF transmission distances compared to existing networks and thereby require more dense networks of access points. Along these lines, access points are, in some instances, being installed in urban areas to serve several city blocks or even to serve a single city block. Such installations are often below roof-top level of surrounding buildings. That is, access points are being installed at ‘steel-level’ sites typically on small poles. The increasing number of access points often requires installation of numerous small cell poles. Accordingly, it is desirable to minimize the cost of each pole. Further, residents in areas where such small cell poles are installed often object to such installation due to the aesthetic concerns such small cell poles. To help alleviate aesthetic concerns, it is desirable to at least partially conceal antennas supported by such small cell poles within shrouding.

### SUMMARY

The present disclosure is directed to a cell pole that is easily manufactured, provides good structural qualities, permits near continuous vertical positioning of supported antennas and/or permits shrouding/concealing of supported antennas. One aspect of the disclosure is based on the realization the importance of line of sight adjustment for newer antennas (e.g., 5G antennas). That is, wireless provides may desire to position their antennas at specific heights (e.g., above ground level). Previously, most small cell poles supported an antenna housing at the top of a pole (e.g., monopole) limiting the ability of wireless providers to select a height for their antennas above ground level. Another aspect of the present disclosure is based on the realization that the per-pole cost may be reduced by utilizing a self-supporting pole that may be manufactured in an extrusion molding process. Such a pole may have a central torsion box and a plurality of outwardly extending flanges. The flanges may extend radially outward from the central torsion box. However, this is not a requirement. Such a pole may provide significant structural rigidity based on the concepts of an I-beam. Further producing such a pole in an extrusion process significantly reduces manufacturing costs. However, extrusion of the pole is not a strict requirement.

In an arrangement, a small cell pole is provided having an elongated generally hollow central member. The central member may form a torsion box of the pole. That is, the hollow central member is a generally tubular member with a sidewall forming a closed geometric shape. The hollow central member has a lower end for attachment to an underlying support surface and a free upper end, when mounted in a generally vertical orientation. A plurality of flanges extending outward from the hollow central member and extending along a length of the hollow central member. In an arrangement, the flanges extend the entirety of the length of the pole. A shroud may extend between free ends of the flanges to define at least partially enclosed antenna bays along a length of the pole. Antenna units may be supported within the bays between the flanges and at least partially behind the shroud. Each bay may be divided into separate bay sections, where each bay section may support an antenna unit. Each bay section may be individually vented.

In an arrangement, the hollow central member has a triangular shape, in cross section, and three flanges attach to the vertexes of the triangular-shaped central member.

In an arrangement, the hollow central member and the plurality of flanges are integrally formed. In such an arrangement, these elements may be formed in an extrusion molding process.

In an arrangement, an antenna may be mounted at any location along the length of the pole between the lower end and upper end of the hollow central member. The configuration of the pole may provide continuous adjustment for an antenna.

In an arrangement, one or more channels and/or protrusions are formed into or onto an outer surface of the hollow central member between adjacent flanges. These channels and/or protrusion may be configured for mounting an element (e.g., antenna, shroud) to the pole.

### BRIEF DESCRIPTION OF THE DRAWINGS

FIG. 1 illustrates one embodiment of a prior art small cell pole.

FIG. 2 illustrate one embodiment of a prior art antenna housing.

FIGS. 3A and 3B illustrate two views of a torsion pole in accordance with the present disclosure.

FIGS. 4A and 4B illustrate cross-sectional views of the different embodiments of the torsion pole.

FIG. 5 illustrates end caps that may be attached to free ends of flanges of the torsion pole.

FIG. 6 a close-up of a portion of one embodiment of a torsion pole.

FIGS. 7A and 7B illustrate two views of another embedment of a torsion pole in accordance with the present disclosure.

FIG. 8 illustrates an antenna unit and ducting that may be utilized with the torsion pole.

FIGS. 9A and 9B illustrate embodiments of channels formed into the sidewall of the torsion box.

### DETAILED DESCRIPTION

Reference will now be made to the accompanying drawings, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

The present disclosure is broadly directed to a wireless antenna support pole (e.g., small cell pole). The cell pole includes a central structural member that, in cross-section, forms a closed geometric shape. The central structural member is referred to herein as a torsion box. Multiple flanges disposed about a periphery of the torsion box (i.e., in cross-section) extend outward along all or a portion of a length (e.g., height) of the torsion box. The torsion box and outwardly extending flanges provide a rigid self-supporting structure. Further, one or more antennas may be mounted between two adjacent flanges. The antennas may be adjusted continually along all or most of the length (e.g., height when the pole is vertically mounted) of the torsion box and/or flanges. In various embodiments, shrouding may extend between the outward ends of the flanges to conceal the antennas within an enclosed interior of the pole reducing the aesthetic obtrusiveness of the pole and supported antennas.

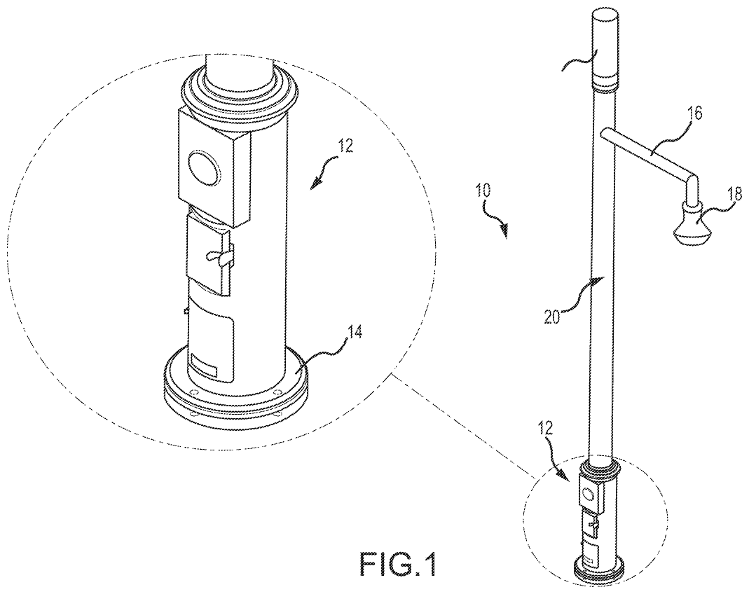

FIG. 1 illustrates one embodiment of a prior art small cell pole 10. Various features of this small cell pole are disclosed in co-owned U.S. Patent Publication No. 2017/0279187, the entire contents of which are incorporated herein by reference. As shown, the cell pole includes a lower equipment housing 12 that includes an inner cavity (e.g., interior) configured to house, for example, cell control equipment. The equipment housing 12 has a lower flange 14 used to mount the housing to a surface (e.g., ground). Other installation methods are possible. Access panels and/or doors may be mounted to the equipment housing 12 to enclose equipment from the elements, while providing selective access, when desired, to modify, regulate, change out, or otherwise access the equipment within the housing 12. The housing may include locks, hinges, access doors, vents for passive radiant cooling, and/or viewing ports. Cable ports and other features may be formed therein during manufacture.

Fasteners, such as threaded posts or bolts, are formed on an upper surface (e.g., flange; not shown) of the equipment housing 12 to facilitate attachment of a monopole 20, which may support an antenna housing 30. In an embodiment, the antenna housing may include, for example, an omnidirectional antenna or trisector antennas disposed within a RF transparent shroud that conceals the antenna. The cell pole 10 has a two-part design: the lower equipment housing 12 and the monopole 20. The illustrated embodiment also illustrates a light mast or arm 16 attached to an upper portion of the pole 20. The illustrated light mast 16 supports a streetlight 18. As set forth in U.S. Patent Publication No. 2017/0279187, the interior of the equipment housing 12 may open into the generally hollow interior of the monopole 20. This allows passage of cables from the equipment housing(s) into the center of the monopole for routing to, for example, one or more antennas and/or lights.

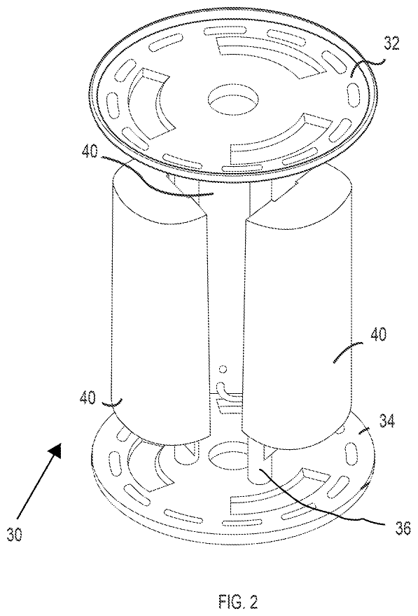

FIG. 2 illustrate one embodiment of an antenna housing 30 with external shrouding removed for illustration. The antenna housing 30 includes an upper annular plate 32 and a lower annular plate 34, respectively. As shown the two plates 32, 34 are disposed in a spaced relationship to define an interior volume there between. This interior volume is sized to house three antenna units 40 therein. These three antenna units may provide 360-degree coverage (e.g., three 120-degree sector antennas). In the illustrated embodiment, three structural supports or struts 36 extend between the upper plate 32 and lower plate 34. The ends of the struts 36 are fixedly attached (e.g., welded, bolted, integrally formed, etc.) to each plate. In the illustrated embodiment, the struts 36 form antenna mounts. The antenna units 40 supported by the antenna housing 30 may each have brackets (not shown) that are configured to attach to at least one of the struts. In various embodiments, such brackets may be affixed to the strut 36 when an antenna unit 40 is in a desired position. U.S. Pat. No. 10,763,575, which is incorporated herein in its entirety, discloses various embodiments of such an antenna housing. While providing an effective means for supporting one or more antennas, the utilization of a dedicated antenna housing to support the antennas limits the vertical positioning of such antennas. That is, adjustment of the height of the antennas above the ground typically requires replacing the monopole with a pole of a desired length.

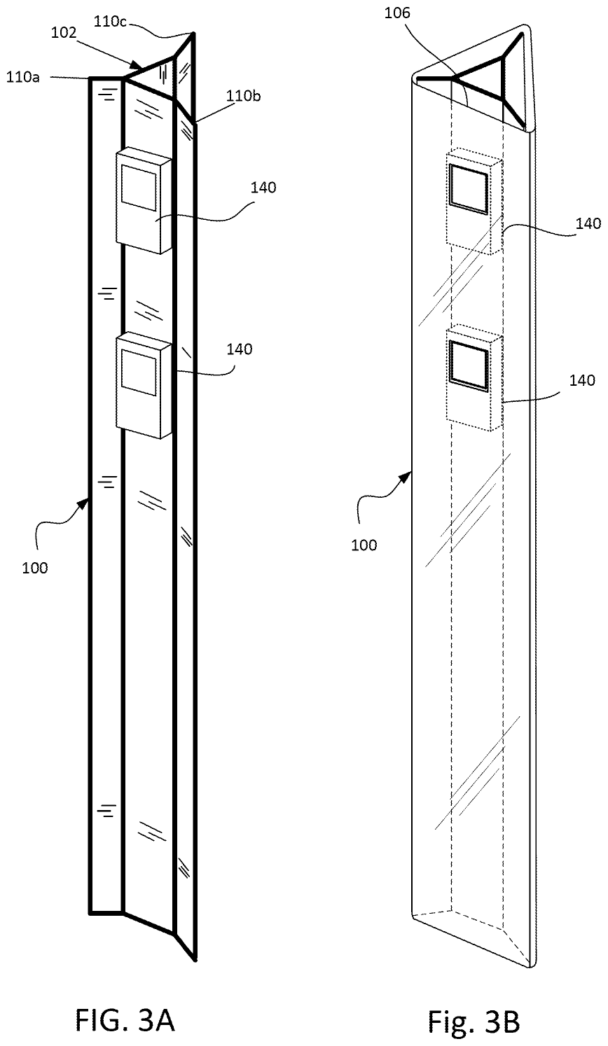

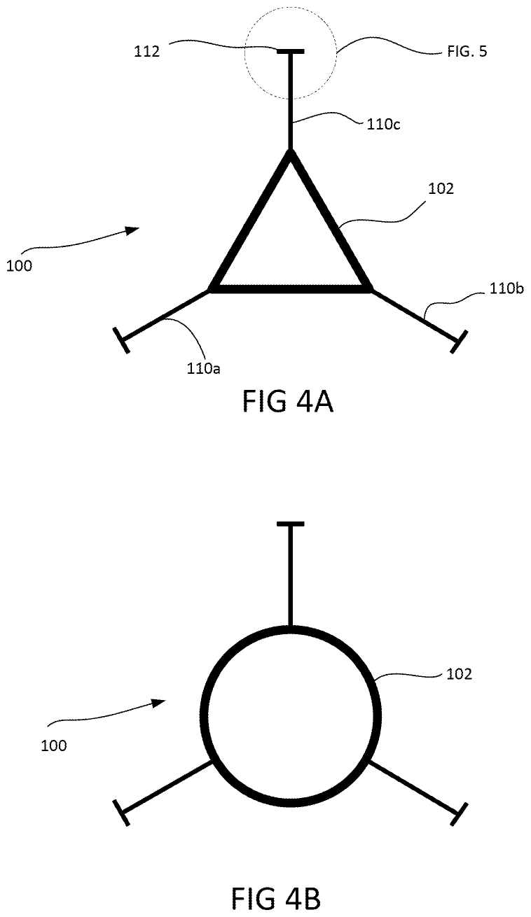

FIGS. 3A, 3B and 4A illustrate one embodiment of a small cell pole or torsion pole 100 in accordance with the present disclosure. As illustrated in FIGS. 3A and 3B, a lower end of the torsion pole 100 may be configured for attachment to a ground surface and/or above an equipment vault (e.g., above ground or subterranean). By way of example, the lower end of the torsion pole 100 may be connected to an equipment housing (not shown) like the pole illustrated in FIG. 1. The torsion pole 100 includes a central support section or torsion box 102 having a sidewall that forms a closed geometric shape. The interior of the torsion box 102 is open (i.e., hollow) providing a conduit from a lower end of the torsion pole to an upper end of the torsion pole. This hollow interior may be utilized to route cabling from, for example, cell equipment housing (not shown) to one or more antenna units 140 supported along the length of the pole.

Extending outward from an outer peripheral surface of the torsion box are plurality of flanges 110a-110c (hereafter 110 unless specifically referenced). In the illustrated embodiment, three flanges 110 extend outward from the torsion box 102. While it is believed that three flanges provide an optimal arrangement as most cellular carriers utilize trisector antennas, it will be appreciated that the number of flanges is not limited to three. That is, other embodiments may utilize fewer or additional flanges. However, for structural support it is believed that a minimum of three flanges is preferred. In the illustrated embodiment, the flanges 110 extend radially outward from a central reference point (not shown) within the interior of the torsion box 102. As illustrated, an inward end/edge of each flange 110 is rigidly connected to the exterior of the torsion box. In embodiment, the torsion box and flanges may be produced in an extrusion molding process such that the torsion box and flanges are integrally formed. In such an arrangement, the torsion pole 100 may be formed from, for example, aluminum or an aluminum alloy. In an alternate embodiment, the flanges may be fixedly attached (e.g., welded) to the torsion box. The flanges may extend for the entire length of the torsion pole. However, this is not a strict requirement and the flanges may extend for less than the entire length (e.g., height) of the torsion pole.

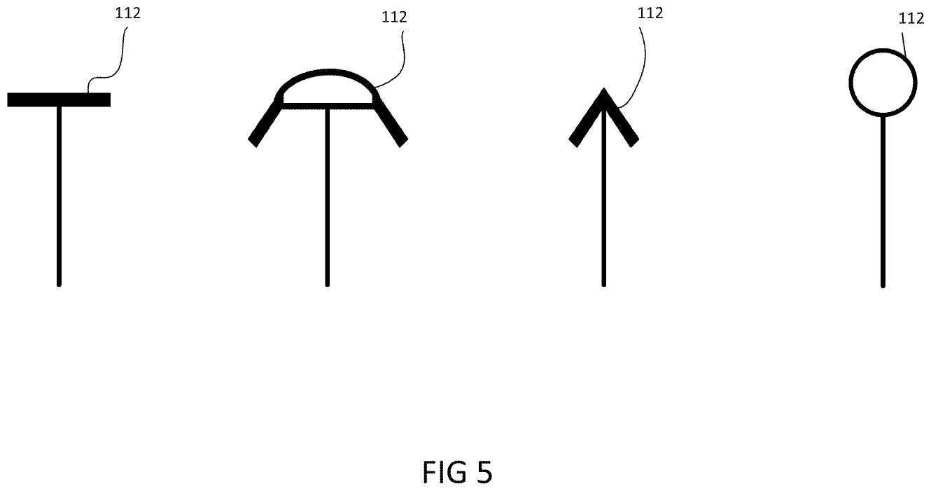

The distal or outward ends of the flanges 110 may include an additional structural component or end cap 112. The end caps 112 may provide additional structural rigidity for the torsion pole like the flanges on an I-beam. Though illustrated as a flat plate in FIG. 4A and omitted in FIG. 3A, the end caps may have a variety of different configurations as generally illustrated in FIG. 5. In various embodiments, the end caps 112 may provide a surface for connecting one or more shrouds to the exterior of the pole 100. This is illustrated in FIG. 3B where a shroud(s) 106 extends between the distal ends of the flanges to enclose the interior of the torsion pole (e.g., enclose bays between adjacent flanges 110) and any supported antennas therein. That is, once one or more antennas units are connected to the torsion box and/or flanges, the antenna units may be at least partially enclosed within the torsion pole by one or more shrouds 106. In an embodiment, one or more shrouds 106 extend between the distal ends of the outwardly extending flanges. Though utilizing the term ‘shroud’, it will be appreciated that any component that at least partially encloses the antenna(s) within an interior of the torsion pole may be utilized. In any embodiment, it may be desirable to at least partially conceal the antennas to provide a finished look and to allow the resulting small cell pole to better blend in with its surroundings. If the shroud(s) covers an active surface of the antenna(s), the covering portion of the shroud is typically made of a material that is substantially transparent (e.g., transmission of greater than 90%) to radiofrequency (RF) waves. Such RF transparent materials include, without limitation, fiber glasses, polymers and/or fabrics. In other arrangements, the shroud(s) may have an antenna aperture(s) (not shown) that exposes an active or emitter surface of each antenna unit 140.

The space between any two adjacent flanges 110 (e.g., antenna bay) may be utilized to mount or house an antenna unit 140. As best illustrated in FIG. 3A, multiple antenna units 140 may be positioned along the height of the torsion pole 100. Further, each antenna unit may be adjusted along the length of the torsion pole between the adjacent flanges at any height as there are no cross structures impeding this movement. That is, the antenna units may be continuously adjusted along the length of the pole. Each antenna unit 140 may be affixed to the outer surface of the torsion box 102 and or to the surfaces of the flanges 110. When a shroud 106 is attached to the torsion pole 100, each bay between any pair of adjacent flanges 110 is substantially isolated from adjacent bays defined by other pairs of flanges. To facilitate airflow through the bays, the shrouds may include various vents. Additionally, one or more fans may be located within each bay to move air through the bay.

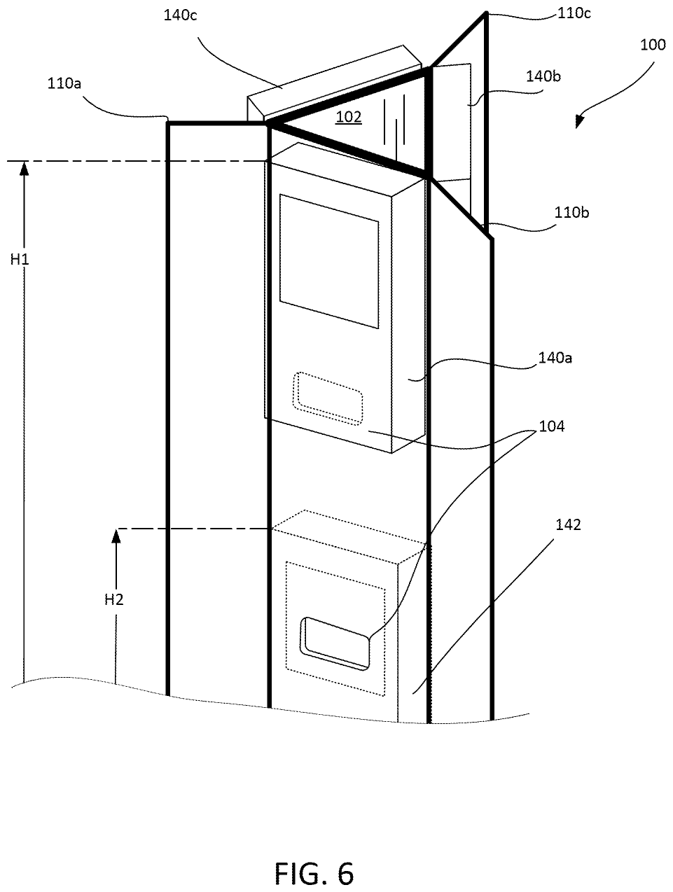

FIG. 6 illustrates a close-up view of an upper end of the torsion pole 100. As illustrated, the torsion pole supports three antenna units 140a-140c at a common height along a length of the pole 100 toward its upper end. More specifically, a first antenna unit 140 a is supported between a first pair of adjacent flanges 110a and 110b, a second antenna unit 140b is supported between a second pair of adjacent flanges 110b and 110c and a third antenna unit 140c is supported between a third pair of adjacent flanges 110c and 110a. To better utilize a cell pole location, it is becoming increasingly common for a cell pole to support two or more sets of antennas (e.g., three antennas forming a tri-sector antenna), which may be disposed in vertically stacked sets. In such an arrangement, wireless antennas of two or more wireless providers (e.g., different wireless providers) may be supported by a single pole. As illustrated in FIG. 6, the pole 100 may support a first set of antennas 140a-140c at a first vertical height H1 and may support a second set of antennas 142 (not all shown) at a second vertical height H2. As further illustrated in FIG. 6, various apertures 104 may be formed through the side wall surface of the torsion box 102. Such apertures 104 may allow for routing cabling (e.g., power and/or communication) to and from the supported antennas via the generally hollow torsion box 102.

The use of ever increasingly powerful antennas units to enhance coverage and/or data transfer can result in thermal management concerns for the small cell pole 110. These concerns are of particular importance when the cell pole 110 incorporates a plurality of stacked antenna units. That is, when two or more antenna units are enclosed within a single bay, heat generated by operation of the antenna units is at least partially contained within the housing/bay. This is of particular concern for upper antenna units (e.g., 140a), which may experience heat rising from lower antenna units (e.g., 142). This can result in some or all the antenna units operating in a thermal environment above recommended operation temperatures. Accordingly, it is desirable to more effectively vent heat generated by each antenna unit from the antenna bay.

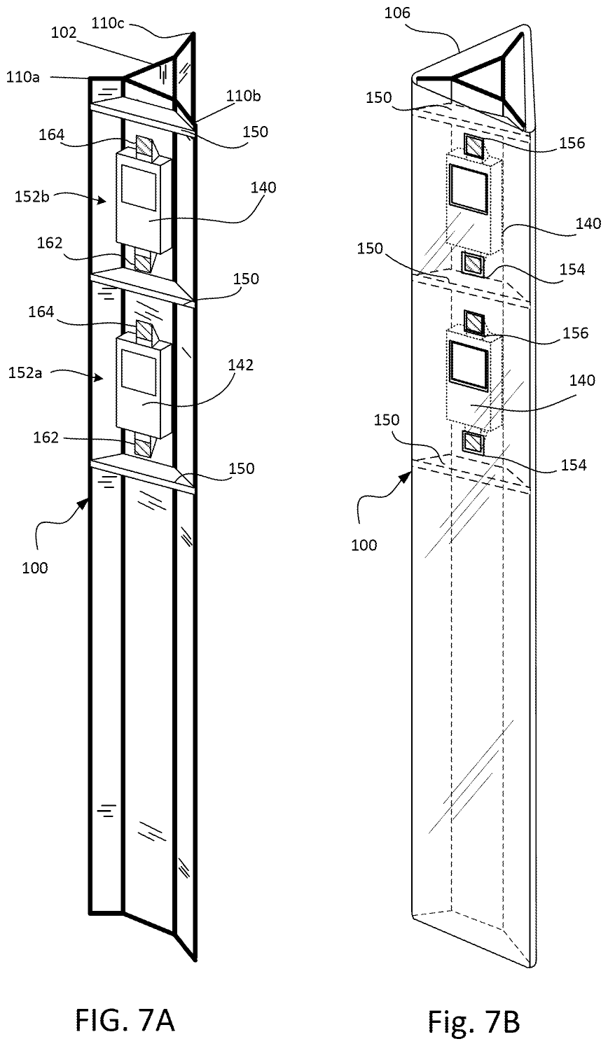

FIGS. 7A and 7B illustrate another embodiment of the torsion pole 100 like the torsion pole illustrated in FIGS. 3A and 3B. Like reference numerals reference like elements. As illustrated, the torsion pole 100 incorporates dividers 150 that are positioned between an upper antenna unit 140 and a lower antenna unit 142 disposed in a common bay (e.g. between adjacent flanges 110a and 110b) of the pole 100. In the illustrated embodiment, the dividers 150 are generally trapezoidal in shape to engage the outer surface of the torsion box 102 and the facing surfaces of the two adjacent flanges 110. As will be appreciated, the divider(s) 150 can have other shapes depending on the configuration of the pole. A rearward edge of the divider 150 is positioned proximate to the torsion box while side edges of the divider 150 are positioned proximate to the adjacent flanges. A forward edge of the divider 150 is configured to be disposed behind the shroud 106, when the shroud 106 is attached to the pole 100. In this regard, the dividers 150 substantially isolate the antenna units 140, 142 into separate sections 152a, 152b (hereafter 152 unless specifically referenced) of the bay between the flanges 100a, 110b. Such separation prevents air heated by the lower antenna unit 142 from passing from a lower antenna unit 142 to the upper antenna unit 140. Further, it will be appreciated that each separate section of the bay may include various vents to inlet and outlet air from the isolated section.

To provide improved cooling of each of the antenna units, ambient air is drawn into each bay section from outside of the antenna bay section (e.g., though an inlet vent opening 154 in the shroud 106) and heated air is exhausted out of the antenna bay section (e.g., through an outlet vent opening 156 in the shroud 106). The inlet vents 154 and outlet vents 156 allow for circulating air through each antenna bay section without that air passing through an adjacent antenna bay section. Along these lines, a fan or blower may be disposed within the interior of each antenna bay section 152.

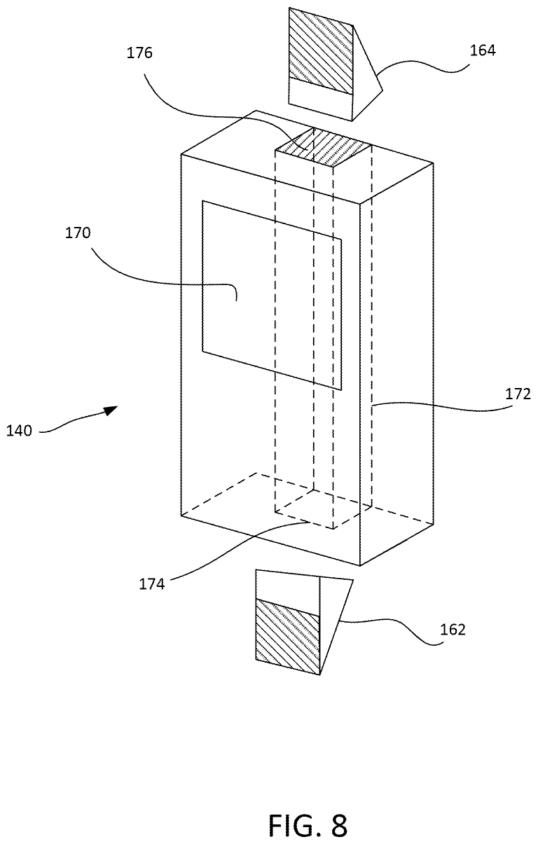

To further enhance the cooling of the individual antenna units (e.g., 140 or 142), each unit may include an inlet duct 162 that is attached to the bottom surface of the antenna unit 140 or 142 and an outlet duct 164 attached to an upper surface of the antenna unit 140 or 142. In an embodiment, the antenna units may each be a Streetmacro 6701 antenna produced by Ericsson. However, it will be appreciated that the antenna housing disclosed herein may be utilized with a variety of antenna units and that this particular antenna unit is presented by way of example only. Nonetheless, the Streetmarco antenna unit is representative of a general form of many 5G antenna units currently being installed. As illustrated in FIG. 8, the antenna unit 140 includes a generally rectangular prism-shaped housing having a front panel or radome 170, which is a thin walled RF transparent area that protects the forward emitting surface of an RF antenna (not shown). The housing of the radio includes an internal cooling duct 172 that passes through the rearward portion of the housing from an inlet 174 in the bottom surface to an outlet 176 in the top surface. The cooling duct 172 passes over a heat rejection surface disposed within the interior of the antenna unit. The heat rejection surface may be a finned surface (e.g., aluminum) attached to a rearward surface of the RF antenna. Commonly, the antenna unit will include a fan (not shown) to move air through the cooling duct 172 from the inlet 174 to the outlet 176. The air passing through the duct 172 passes over a heat rejection surface thereby cooling the antenna.

In the present embodiment, a first or lower end of the generally hollow outlet duct 164 connects to an upper surface of the antenna unit 140 around the outlet 176. A second or upper end of the outlet duct 164 is configured to engage one of the outlet vent openings 156 in the shroud 106 (see FIG. 7B.). Likewise, a first end of the generally hollow inlet duct 162 connects to a lower surface of the antenna unit 140 around the inlet 174. A second end of the inlet duct 162 is configured to engage one of the inlet vent openings 154 in the shroud 106. Similar ducts for use in connecting a wireless radio to inlet and outlet vents are set forth in co-owned U.S. patent application Ser. No. 16/837,234 filed on Apr. 1, 2020, the entire contents of which is incorporated herein by reference. The ducts 162, 164 allow the antenna unit 140 to draw air from outside of the antenna bay section 152 through the cooling duct 172 (i.e., over a heat rejecting surface(s)) and expel the air out of the antenna bay section. Such air may pass through the antenna unit without intermingling with air in the interior of the antenna bay section. That is, air used to cool the antenna unit never comingles with air in the interior of the antenna bay section. This arrangement significantly reduces the internal temperature of the antenna bay section. In the absence of such an air flow path, air would be drawn into the internal cooling duct 172 of the antenna unit from the interior of the antenna bay section and expelled back into the interior of the antenna bay section 152. This would result in inefficient cooling of the antenna and increased temperatures within the antenna bay. It will be appreciated that antenna units that lack an internal cooling duct may be partially disposed within a plenum that connects to the inlet and outlet ducts, as set forth in U.S. patent application Ser. No. 16/837,234, as incorporated above.

In any embodiment, the torsion box and flange pole configuration provides a self-supporting rigid pole that may also provide continuous vertical adjustment along its length for supported antenna units. Though primarily illustrated in relation to utilizing a torsion box have a triangular shape, it will be appreciated that the torsion box may have other shapes. For instance, as illustrated in FIG. 4B, the torsion box 102 may be circular. Other shapes are possible though in any configuration it may be desirable that the torsion box have a close geometric shape in cross-section to provide torsional rigidity to withstand, for example, wind loading or other loads that provide a moment on the pole (e.g., light masts). Further, it is desirable that the torsion box have a hollow interior such that various cabling may be routed through the interior of the pole.

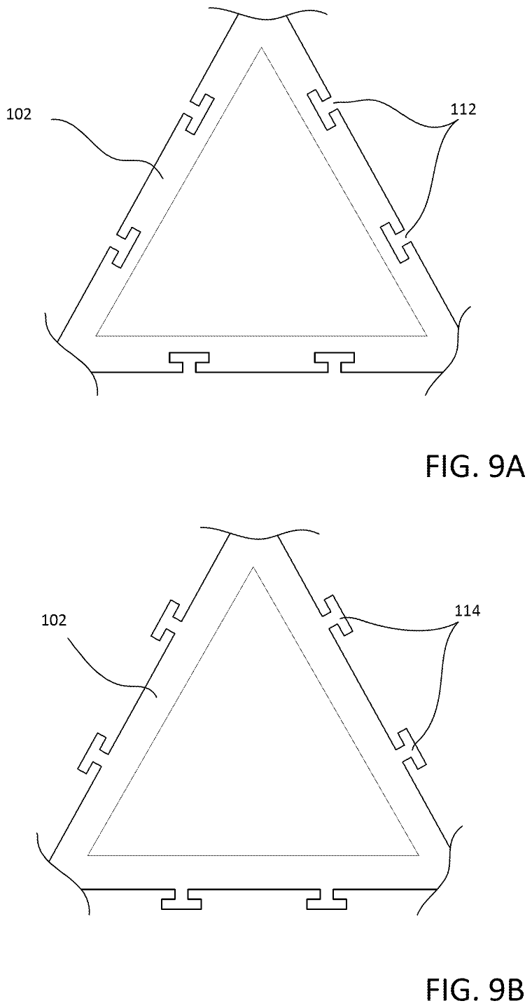

FIGS. 9A and 9B illustrate a further embodiment of the torsion box 102. In this embodiment, the torsion box 102 is formed having various channels 112 or protrusions 114 formed within or on its outer sidewall. Such channels or protrusions may be utilized to mount an antenna unit to the pole utilizing correspondingly configured connectors. Further, such channels or protrusions may be integrally formed with the torsion pole. By way of example, when the torsion pole is formed an extrusion process such channels or protrusions may be formed during the extrusion process. In such an arrangement, the channels or protrusions may extend the entire length of the torsion box 102. In another arrangement, channels and/or protrusions may be formed along the length of one or more of the flanges (not shown).

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. A small cell pole, comprising:
an elongated hollow central member, the hollow central member having a lower end for attachment to a support surface and a free upper end;
a plurality of flanges extending outwardly from the hollow central member and extending along a length of the hollow central member;
a first antenna unit disposed between a first adjacent pair of the plurality of flanges; and
a shroud extending between the first adjacent pair of the plurality of flanges, wherein the shroud extends over and at least partially covers the first antenna unit.

2. The pole of claim, wherein the hollow central member has a sidewall forming a closed geometric shape.

3. The pole of claim 2, wherein the hollow central member is a triangular hollow central member.

4. The pole of claim 3, wherein the plurality of flanges comprises three flanges attached proximate to vertexes of the triangular hollow central member.

5. The pole of claim 1, wherein each flange has an inner end fixedly attached to the hollow central member and a free outer end.

6. The pole of claim 5, wherein the free outer end further comprises an end cap.

7. The pole of claim 1, wherein the hollow central member and the plurality of flanges are integrally formed.

8. The pole of claim 1, further comprising:
a channel or protrusion formed into or onto an outer surface of the hollow central member between adjacent flanges, wherein the channel or protrusion is configured for mounting an element to the pole.

9. The pole of claim 1, further comprising:
a second antenna unit disposed between a second adjacent pair of the plurality of flanges; and
a third antenna unit disposed between a third adjacent pair of the plurality of flanges.

10. The pole of claim 1, further comprising:
a second antenna unit disposed between the first adjacent pair of the plurality of flanges, wherein the first antenna unit is disposed at a first height along a length of the pole and the second antenna unit is disposed at a second height along a length of the pole.

11. The pole of claim 10, further comprising:
a divider disposed at a third height between the first antenna unit and the second antenna unit, wherein the divider separates a space defined between the first adjacent pair of the plurality of flanges into a first section including the first antenna unit and a second section including the second antenna unit.

12. The pole of claim 11, wherein a periphery of the divider is juxtaposed against the hollow central member, the first adjacent pair of the plurality of flanges and an inside surface of the shroud.

13. The pole of claim 11, wherein the shroud further comprises:
an inlet vent and an outlet vent in the first section, wherein the vents are apertures through the shroud.

14. The pole of claim 13, further comprising:
an inlet duct having a first end connected to the inlet vent; and
an outlet duct having a first end connected to the outlet vent.

15. The pole of claim 14, wherein a second end of the inlet duct connects to a cooling duct associated with the first antenna unit and a second end of the outlet duct connects to the cooling duct associated with the first antenna unit.

16. A small cell pole, comprising:
an elongated hollow central member, the hollow central member having a lower end for attachment to a support surface and a free upper end;
three spaced flanges extending outwardly from the hollow central member and extending along a length of the hollow central member;
a shroud extending between a first adjacent pair of the three spaced flanges, a second pair of the three spaced flanges and a third pair of the three spaced flanges, wherein the shroud and the three flanges define three enclosed antenna bays along a length of the pole.

17. The pole of claim 16, wherein the hollow central member has a sidewall forming a closed geometric shape.

18. The pole of claim 17, wherein the hollow central member is a triangular hollow central member.

19. The pole of claim 18, wherein the three spaced flanges are attached proximate to vertexes of the triangular hollow central member.

20. The pole of claim 16, wherein the hollow central member and the three flanges are integrally formed.
